(19) United States
(12) Patent Application Publication
(10) Pub. No.: US 2025/0343416 A1
(43) Pub. Date: Nov. 6, 2025

(54) GRID FORMING CONTROL

(71) Applicant: Siemens Gamesa Renewable Energy A/S, Brande (DK)

(72) Inventors: Thyge Knueppel, Værløse (DK); Brian SOLBERG, Rødrove (DK); Michael Stoettrup, Herning (DK)

(21) Appl. No.: 18/864,918

(22) PCT Filed: May 17, 2023
(86) PCT No.: PCT/EP2023/063250

§ 371 Date: Nov. 12, 2024

(30) Foreign Application Priority Data
May 17, 2022 (EP) 22173846.1

(51) Int. Cl. H02J 3/24; G05B 15/02; H02J 3/00; H02J 13/00

(52) U.S. Cl. CPC H02J 3/24; G05B 15/02; H02J 3/001; H02J 13/00002

(57) ABSTRACT

A method of controlling a power generation system is provided. The power generation system may be electrically coupled to a power grid and may include a power generation unit generating electrical power and a converter system coupled to the power grid. The converter system may convert at least electrical power that is exchanged between the power generation unit and the power grid. The method may include operating the converter system in a grid forming operation mode in which the converter system may control the exchange of electrical power with the power grid to support a grid voltage and/or a grid frequency. During a disturbance of the power grid, the exchanged electrical power may comprise a stabilizing component that may provide the support.

### CROSS-REFERENCE TO RELATED APPLICATIONS

This application is a national stage of PCT Application No. PCT/EP2023/063250, having a filing date of May 17, 2023, which claims priority to EP application Ser. No. 22/173,846.1, having a filing date of May 17, 2022, the entire contents both of which are hereby incorporated by reference.

### FIELD OF TECHNOLOGY

The following relates to a method of controlling a power generation system. It further relates to a computer program for performing such method, and to a control system and a power generation system configured to carry out such method.

### BACKGROUND

Today, the grid frequency is controlled by large power plants with synchronous generators, and the inertia of these machines helps to stabilize the power grid to a rated grid frequency of 50 or 60 Hz. The increasing use of renewable energy sources, e.g., wind turbines or photovoltaic solar systems, in or as power generation systems may provide less support for the power grid, since such renewable energy sources create only little or no inertia. Further, the power output of renewable energy sources varies in dependence on current environmental influences. However, with advanced converter control, the grid connected converter of a renewable energy source may emulate selected properties of a synchronous generator and operate in a grid forming mode, in which the renewable energy source inherently exchanges power with the power grid, in particular in response to a disturbance of grid frequency or angle, to continuously support the grid frequency.

The amount of disturbance power that is exchanged with the power grid in the grid forming mode in response to a disturbance on the power grid depends on the grid forming control parameterization and the characteristics of the grid event. A power converter is, unlike a synchronous machine, a current limited device that is normally operated with only small current margins. It is a power electronic device and, unlike a synchronous generator with its inherent stored kinetic energy in its rotating masses, there is normally only very little energy stored in the device. The lack of inherent capability to deliver the power and energy during e.g., an inertial response poses a challenge for a grid forming control scheme. If the converter or the generator system is pushed beyond its respective capability, it may be damaged or may disconnect during the disturbance.

To avoid such problems, the grid forming operated renewable energy source may be designed so as to be able to deliver the worst case disturbance power, e.g., by using suitably rated hardware components that are capable of providing both the power and the energy requested by the power grid in the worst case. However, this results in an overrating of the system components on hardware level and an increased hardware effort, e.g., by including additional power sources as for example a dedicated storage device. Moreover, since the amount of disturbance power depends on the grid forming control parameterization, the system should be parameterized so as to consider both a worst case operating point of the renewable energy source and the worst case grid event. However, such rather conservative parameterization limits the stabilizing contribution of the renewable energy source and may thus lead to an inefficient grid forming operation.

The document “Synchronous Power Controller With Flexible Droop Characteristics for Renewable Power Generation Systems”, ZHANG WEIYI ET AL, IEEE TRANSACTIONS ON SUSTAINABLE ENERGY, IEEE, USA, vol. 7, no. 4, 1 Oct. 2016, pages 1572-1582,XP011623289, DOI: 10.1109/TSTE.2016.2565059 is related to a synchronous power controller for-grid connected converters for renewable generation systems with energy storage. Different from the replication of the swing equation of synchronous machines, an alternative control structure is proposed, by which the damping and inherent droop slope can be configured independently to meet the requirements in both dynamics and frequency regulations.

The document EP 3 734 799 A1 relates to a method of controlling a wind turbine or a wind park comprising at least one wind turbine connected to a utility grid for utility grid support. In embodiments, the method may comprise receiving a (utility grid support) control command from a utility grid manager and controlling the wind turbine according to a mode selected by the control command. The control command may indicate the wind turbine to switch to a grid forming mode of operation from a current control mode.

The document WO 2020/254161 A1 relates to a method for controlling a wind turbine system connected to a power grid. In embodiments, the method comprises generating a wind turbine control signal based on a power control reference for controlling a power output of a wind turbine, monitoring an electrical frequency of the power grid, and in response to detecting a change in the frequency in the power grid, activating a fast frequency support method which comprises adjusting the power control reference to cause an overproduction of power by the wind turbine, wherein the power control reference is determined by applying an adaptive gain function to a measurement of a difference in grid frequency from a nominal level.

### SUMMARY

An aspect relates to the operation of a power generation system in a grid forming operation mode.

According to an aspect, a method of controlling a power generation system is provided. The power generation system may be electrically coupled to a power grid and may comprise a power generation unit generating electrical power and a converter system coupled to the power grid. The converter system may convert at least electrical power that is exchanged between the power generation unit and the power grid. In embodiments, the method may comprise operating the converter system in a grid forming operation mode in which the converter system may control the exchange of electrical power with the power grid to support a grid voltage and/or a grid frequency. During a disturbance of the power grid, the exchanged electrical power may comprise a stabilizing component that may provide the support (the stabilizing component may in particular be provided to resist or counteract the disturbance). In embodiments, the method may further comprise controlling the power generation system to at least one of limit the stabilizing component of the exchanged electrical power by controlling the converter system, enforce the stabilizing component of the exchanged electrical power, and block the stabilizing component of the exchanged electrical power.

This way, the electrical power exchanged between the power generation system and the power grid may vary only in a predetermined range during grid forming operation. The system may therefore be protected when a grid disturbance occurs. A system response may be prevented that would cause the system to operate in an operating point that may be harmful to or overload system components, that may not be supported by the components on hardware level, and/or that may be inefficient. Therefore, the method may improve the efficiency of the power generation system. Further, the burden on the system is reduced in a controlled way which may result in a higher robustness and lifetime of the system. Moreover, the parameterization of the grid forming control is no longer limited to worst case scenarios and, thus, not limited to a conservative and rather inefficient parameterization. Instead, the grid forming control may be parameterized so as to respond more powerfully to regularly occurring grid disturbances yielding in a more robust power grid. Moreover, an overrating of the power generation system on hardware level may not be required. In summary, the operation of a power generation system in a grid forming operation mode may be improved.

In an embodiment, the enforcing may comprise temporarily blocking a response to a shifted operating point of the power generation system.

Limiting the stabilizing component may in particular occur by applying one or more respective limits to the stabilizing component, in particular by keeping the stabilizing component within one or more predefined, in particular static, or dynamic limits. Alternatively, the one or more limits may be applied to the power reference, a parameter indicative of the power reference or the electrical power that is exchanged with the power grid in order to limit the stabilizing component.

The limiting, enforcing and/or blocking may be performed by a control system that controls the power generation system, and the control system may be configured to implement one, two or all three of these control functions. It may for example be configured to be capable of performing at least the limiting function, or at least the limiting and the blocking functions, or may be configured to be capable of performing the limiting, the blocking and the enforcing functions, or any other combination. Which function is performed may for example depend on one or a combination of properties of the disturbance, operating parameters of the power generation system and a setting of the control system, as explained in more detail hereinafter. For example, the stabilizing component may only be limited; may first be limited and then blocked; may only be enforced; may first be enforced, then optionally limited and then blocked; or may directly be blocked. Other combinations are possible.

The limiting, enforcing and/or blocking may be performed in response to obtaining, e.g., generating or receiving, a limiting signal, an enforcing signal and/or a blocking signal or in response to obtaining the parameter being indicative of at least one of the limiting, the enforcing and the blocking.

The power generation unit may be but is not limited to a component being capable of receiving and/or outputting electrical power, e.g., an electrical generator, for example the generator of a wind turbine, in particular an asynchronous or synchronous generator, or a photovoltaic system, e.g., a photovoltaic module, or an energy storage system.

The power generation system may comprise one or more power generation units.

The converter system may be a power converter for converting electrical energy. The power converter may convert alternating current (AC) into direct current (DC) and vice versa, or AC to AC. The converter may change the voltage or frequency of the current or provide a combination of these. The converter system may comprise a DC-link.

The grid voltage may be a grid voltage amplitude and/or the grid frequency may be at least one of a frequency of the grid voltage or the grid current.

The electrical power may comprise active power and/or reactive power.

The stabilizing component may be at least a portion of the exchanged electrical power. It may also be possible that the exchanged electrical power comprises only or consists of the stabilizing component.

The disturbance of the power grid may for example be a deviation of the grid voltage and/or the grid frequency from a pre-event grid voltage and/or grid frequency, where pre-event (i.e., prior to the occurrence of the disturbance), the power system may be operated at rated voltage and/or rated frequency. The disturbance may be a grid voltage and/or a grid frequency that is higher or lower than the respective rated value, e.g., higher or lower than a nominal grid frequency of, e.g., 50 Hz or 60 Hz. The disturbance may for example be a frequency fluctuation or a voltage sag.

The power generation system may be controlled so as to exchange electrical power with the power grid in accordance with a reference power and embodiments of the method may further comprise generating or receiving a parameter being indicative of at least one of the limiting, the enforcing, and the blocking, and embodiments of the method may further comprise at least one of limiting, enforcing, and blocking the power reference in accordance with the parameter.

According to an example, limiting the stabilizing component may comprise limiting a magnitude of the electrical power that is exchanged with the power grid, and/or limiting a power rate of the electrical power (e.g., rate of change of the electrical power) that is exchanged with the power grid. This may occur by applying a respective magnitude limit and/or a respective rate limit.

The limiting of the magnitude or the power rate may reduce the load on the power generation system. For example, the power characteristics may be limited to such that the burden on the power generation system or certain components thereof is sustainable for the system.

The exchanged electrical power may comprise the stabilizing component and a further component, and during the disturbance, exchanging the further component may be at least one of maintained, limited, blocked and enforced. In an example, exchanging the further component may be at least one of maintained, limited, blocked and enforced instead of or in addition to the stabilizing component. It should be clear that an aspect of the embodiments of the invention is to limit a burden on the power generation system when a disturbance occurs. Hence, an arbitrary component of the (total) exchanged power may be limited or blocked to achieve the reduction while certain components are maintained or enforced, e.g., due to grid requirement as for example a required inertia response of the power generation system.

According to an embodiment, the method may comprise operating the power generation system such that the power generation system performs a maximum power point tracking, in particular during the grid forming mode. Renewable energy sources may routinely be operated in such a way. When a wind turbine is operated in maximum power point tracking, it may not be possible to extract any additional power from the wind. Additionally, any reduction in rotor speed, if e.g., additional power is extracted, may lead to a less optimal operating point (smaller power production).

Such method may allow that the power generation system generates a maximized power output while being operated in a grid forming mode. Since the converter system may be controlled to limit or block the stabilizing power that may be additionally required in such mode, the system may be operated while avoiding pushing the power generation system into undesirable operating points. For a wind turbine, undesirable operating points may include if the rotor speed is reduced to cut-out where the wind turbine is stopped or if the power reduction in the resulting recovery period is too severe compared to the positive contribution of the stabilizing power.

According to an embodiment, the method may comprise monitoring the grid voltage and/or the grid frequency to generate a monitored grid voltage and/or a monitored grid frequency, determining an operation mode based on the monitored grid voltage and/or the monitored grid frequency, and modifying, based on the operation mode, at least one of the limiting, the enforcing and the blocking of the stabilizing component.

The modifying based on the operation mode may allow on-the-fly-adaption of the actions of limiting, enforcing or blocking to currently monitored grid characteristics. For example, the modifying may comprise a modification of how and when an action is applied and/or an enabling/disabling of one of the actions. As a result, the power generation system operates more efficiently.

Monitoring may herein for example be performed—but is not limited to—by at least one of a sensor, a sensoring system, a model being implemented in software, and a filter-based monitoring system, which may for example be a state observer, Kalman filter or the like. Monitoring may further comprise signal pre- and post-processing, e.g., filtering. Further, monitoring may utilize information obtained from hardware, e.g., one or more sensors, that is implemented for the purpose of monitoring and/or may utilize information obtained from hardware that is implemented for another purpose. Monitoring may further comprise an estimating and/or predicting, based on obtained information.

According to an embodiment, the method may comprise decoupling the power generation system from the power grid when the stabilizing component is blocked, which may for example occur if the power generation system fails to limit, in amplitude or speed, the stabilizing component. The blocking may in particular comprise tripping the power generation system, in particular to prevent additional stabilizing components from being drawn.

The decoupling or disconnecting may be hardware-based, e.g., by a circuit-breaker. A decoupling or disconnecting from the grid when the stabilizing component is blocked may be advantageous, since it prevents the power generation system from exchanging electrical power on such a level that may be harmful to the system.

According to an embodiment, the method may comprise determining a disturbance power and/or a disturbance energy that may be required to be exchanged with the power grid in response to an occurrence of the disturbance. At least one of the limiting, the enforcing and the blocking of the stabilizing component may be based on at least the disturbance power and/or the disturbance energy. In an embodiment, at least one of the limiting, the enforcing and the blocking of the stabilizing component may be further based on one or more operation parameters of the power generation system and in particular, on one or more operation parameters of the power generation unit and/or on one or more operation parameters of the converter system.

The disturbance power may be, while the power generation system is connected to the power grid, a power difference between the (actual) electrical power that is exchanged between the power generation system and the grid, and a reference electrical power that is to be exchanged. The disturbance energy may be an integral of the disturbance power over time. In embodiments, the disturbance power may correspond to or may be the stabilizing component. A reference electrical power may correspond to a power setpoint provided by a system controller, e.g., a wind turbine controller or wind farm controller.

The one or more operation parameters of a system/component may for example be one or more parameters of the system/component when operating the system/component in a certain operating point. For a wind turbine, these may comprise a wind speed, a yaw angle of the nacelle, a pitch angle of the rotor blades, a rotating speed of the rotor of the wind turbine or of the generator, a current or a voltage, or the like.

Whether and/or how the stabilizing component is limited, enforced or blocked may depend on the severity of the disturbance and, in particular, on the amount of power and energy that is required for the stabilizing in response to such disturbance. It may depend additionally or alternatively on the current operating point of the power generation system. For example, the stabilizing component may be limited or blocked when the required power for the stabilizing is higher than the maximal power which the system is capable to provide, e.g., in total or based on the current operating point. It may also be possible that for responding to the disturbance, the system would be required to operate in a state of power overproduction that is long enough to be harmful for the system, e.g., due to a persistent production of an electrical overcurrent or because the mechanical torque increases beyond the design limits. In such cases, the stabilizing component may also be limited or, as a last resort, blocked. It may also be possible that for responding to the disturbance, an operating point of the power generation system is required to be shifted from an efficient operating point of the power generation system to a less efficient operating point. A return from the less efficient operating point may require a high effort, e.g., high amount of electrical power. For example, when it is assumed that the power generation unit is a wind turbine generator, such shift of the operating point may comprise a significant deceleration of the wind turbine. To limit the extent by which the system is shifted into the inefficient operating point, the stabilizing component may be limited.

Accordingly, embodiments of the method may be advantageous, since the power generation system may respond only to such extent for which a response does not involve efficiency drawbacks or a risk of failure of the system.

According to an example, the power generation system may be controlled so as to exchange power with the power grid in accordance with a reference power. In embodiments, the method may comprise monitoring the power that is exchanged with the power grid to generate a monitored power. The disturbance power may be determined based on a difference between the monitored power and the reference power. In an embodiment, the method may further comprise filtering the difference before the disturbance power is determined. The reference power and the monitored power may be but are not limited to a reference active power and a monitored active power, respectively. The filter may for example be a low-pass filter, in particular a mean filter or a moving average filter.

Such method may be beneficial, since the disturbance power is computed based on intermediate results that are available in the control system of the power generation system. Thus, the computation performance may be increased. In an embodiment, the filtering may filter for high frequency related signal parts of the disturbance power such that the system is prevented from responding to signal parts that are for example related to noise. Accordingly, the system may operate more efficiently.

According to an embodiment, a power controller may control the power output of the power generation unit, and the method may comprise providing, by the power controller, the reference power. The power controller may for example be a wind turbine controller that controls the power output (e.g., directly or indirectly by providing setpoints for the converter system), or a solar unit or solar plant controller or the like.

The converter system may be controlled by a converter system controller and the reference power may be provided to the converter system controller. In embodiments, the method may comprise generating or receiving a parameter being indicative of at least one of the limiting, the enforcing and the blocking. In embodiments, the method may comprise at least one of limiting, enforcing and blocking the power reference in accordance with the parameter.

In an embodiment, the limited, enforced and/or blocked reference power may comprise a magnitude and/or a rate of change below a magnitude and/or a rate of change of the reference power before the limiting, enforcing, and/or blocking.

In an embodiment, monitoring the power may comprise monitoring a grid voltage and a grid current to generate a monitored grid voltage and a monitored grid current, respectively. The monitored power is generated by deriving the monitored power from the monitored grid voltage and the monitored grid current.

According to an embodiment, the method may further comprise integrating a parameter that is indicative of the disturbance power. The disturbance energy may be determined based on the integrated parameter. The parameter may for example be the difference between the reference power and the monitored power or instead of a parameter that is indicative of the disturbance power, the disturbance power itself. In an embodiment, the method may further comprise filtering the integrated parameter before the disturbance energy is determined. The filter may for example be a low-pass filter, in particular a mean filter or a moving average filter.

According to an embodiment, the method may comprise determining that the disturbance power and/or the disturbance energy exceeds a respective threshold, and/or determining that when the stabilizing component is exchanged with the power grid, at least one of the operation parameters of the power generation system, in particular of the power generation unit and/or the converter system, exceeds a respective threshold. The stabilizing component may be limited in response to the threshold being exceeded. The stabilizing component may be blocked, e.g., by tripping the power generation unit, if the disturbance power and/or the disturbance energy cannot be kept within the respective threshold, and/or the at least one operation parameter of the power generation system cannot be kept within the respective threshold by limiting the stabilizing component.

The threshold may for example be predetermined or predefined. The threshold may comprise a limit of an (internal and/or external) operation parameter of the power generation system or of components of the power generation system. In embodiments, the threshold for an internal operation parameter may be based on hardware capabilities and/or hardware limits of the system. For example, the threshold may comprise a power limit and/or a stored energy limit. The power/energy limit may be indicative of a maximum power/energy that the power generation system is, or components of the power generation system are, capable to provide. Alternatively or additionally, the threshold may comprise a current limit and/or a voltage limit. The threshold may further comprise a charging state limit, e.g., of the DC-link of the converter. In the case that the power generation unit comprises a generator, the threshold may alternatively or additionally comprise a speed limit, a change of speed limit and/or torque limit. In the case that the power generation unit comprises an energy storage, the threshold may for example comprise a charging state limit. The threshold may be dependent on the operating point of the power generation system, so that the allowable amplitude and/or rate of change of the stabilizing component may depend on one or more operating conditions of the power generation system. The threshold may additionally or alternatively comprise limits that are related to one or more internal or external operation parameters, e.g., when the power generation system comprises a wind turbine: a wind speed limit, a rotor or generator speed limit, an active power output limit, an available power measurement or estimation or a wind strength limit.

As a result, the power generation system may be prevented from responding to such disturbance, a response may be prevented which would be harmful to the system, e.g., when the response would overload the system, and/or which would shift the current operating point towards an inefficient operation, e.g., when the response would greatly decelerate the rotor speed from its pre-event operating point.

According to another aspect, a control system for controlling a power generation system is provided. The power generation system may be configured to be electrically coupled to a power grid and may comprise a power generation unit configured to generate electrical power, and a converter system configured to be coupled to the power grid. The converter system may be configured to convert at least electrical power that is exchanged between the power generation unit and the power grid. The control system may be configured to perform any of the methods described herein.

The control system may for example comprise a processing unit and a memory, the memory storing control instructions which when executed by the processing unit of the control system, cause the control system to perform any of the methods described herein. The processing unit may for example comprise a digital signal processor, an application specific integrated circuit, a field programmable gate array, a microprocessor or the like. The memory may comprise RAM, ROM, flash memory, a hard disk drive and the like.

The control system may comprise a plurality of control systems. The plurality of control systems may be communicatively coupled with each other and/or the control systems may be comprised by one or more components of the power generation system. Each of the plurality of control systems may comprise a processing unit and a memory unit. The control system may be configured to perform any of the methods described herein, wherein steps of the method may be performed distributed over the plurality of control systems.

For example, the control system may comprise a power controller configured to control an operation of the power generation unit and/or of the overall power generation system, and a converter system controller (e.g., converter control unit, CCU) configured to control an operation of the converter system. In embodiments, in the case of a wind turbine, the control system may comprise a power controller in form of a wind turbine controller configured to control the operation of the wind turbine (which may comprise the providing of a power reference) and a converter system controller configured to control an operation of the converter system.

The control system may be comprised in the power generation system. Alternatively, the control system may be a separate unit.

According to another aspect, a power generation system is provided. The power generation system may be configured to be electrically coupled to a power grid. The power generation system may comprise a power generation unit configured to generate electrical power, and a converter system configured to be coupled to the power grid. The converter system may be configured to convert at least part of the electrical power that is exchanged between the power generation unit and the power grid. The power generation system may comprise any one of the control systems described herein.

The power generation system may be controlled by a first controller (e.g., power controller) and the converter system may be controlled by a second controller (e.g., converter system controller). The first controller may be configured to provide a control command to the second controller, the control command controlling the exchange of electrical power between the power generation system and the power grid. The first controller may further be configured to provide a limit for the control command to the second controller. The power generation system may be configured to apply the limit via control system in order to limit the exchange of the electrical power. The limiting may be performed by the second controller, in particular via the converter control, to bring the disturbance power within the received limit.

In an embodiment, the power generation unit may be an electrical generator of a wind turbine. In another example, the power generation unit may be a photovoltaic solar system, which may be controlled by the first controller.

According to another aspect, a computer program product (non-transitory computer readable storage medium having instructions, which when executed by a processor, perform actions) for controlling a power generation system is provided. The computer program may comprise control instructions which, when executed by one or more processing units, cause the one or more processing units to perform any of the herein described methods. The computer program may be provided on a volatile or non-volatile storage medium or data carrier.

It is to be understood that the features mentioned above and those yet to be explained below can be used not only in the respective combinations indicated, but also in other combinations or in isolation, without leaving the scope of the present invention. In embodiments, the features of the different aspects, embodiments and/or examples of the invention can be combined with each other unless noted to the contrary.

### BRIEF DESCRIPTION

Some of the embodiments will be described in detail, with references to the following Figures, wherein like designations denote like members, wherein:

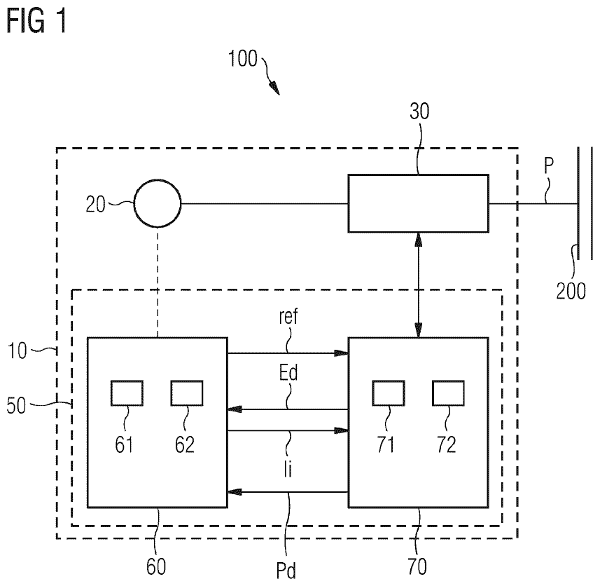

FIG. 1 is a schematic drawing showing a power generation system and a control system, and a signal flow illustrating an operation of controlling the power generation system according to an example;

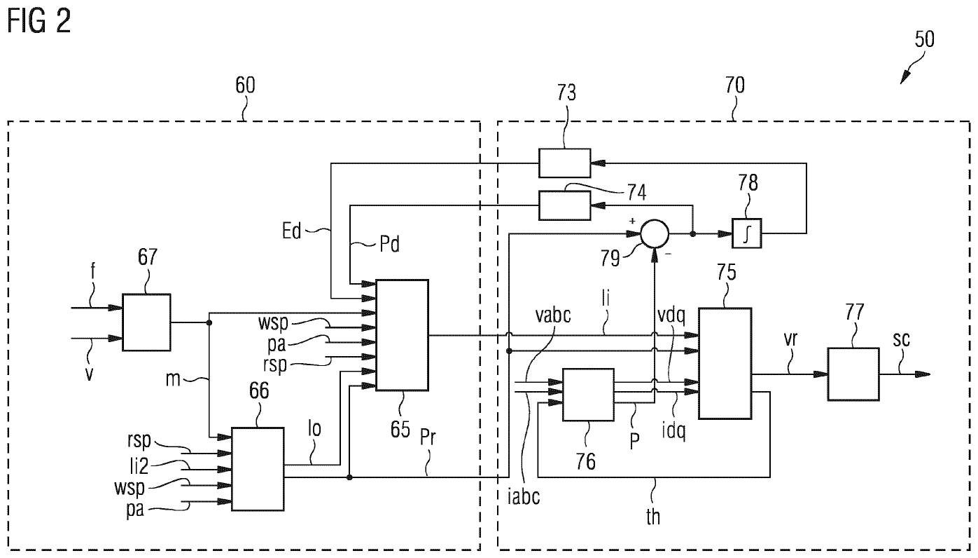

FIG. 2 is a schematic drawing showing the control system and a signal flow illustrating an operation of controlling the power generation system according to an example;

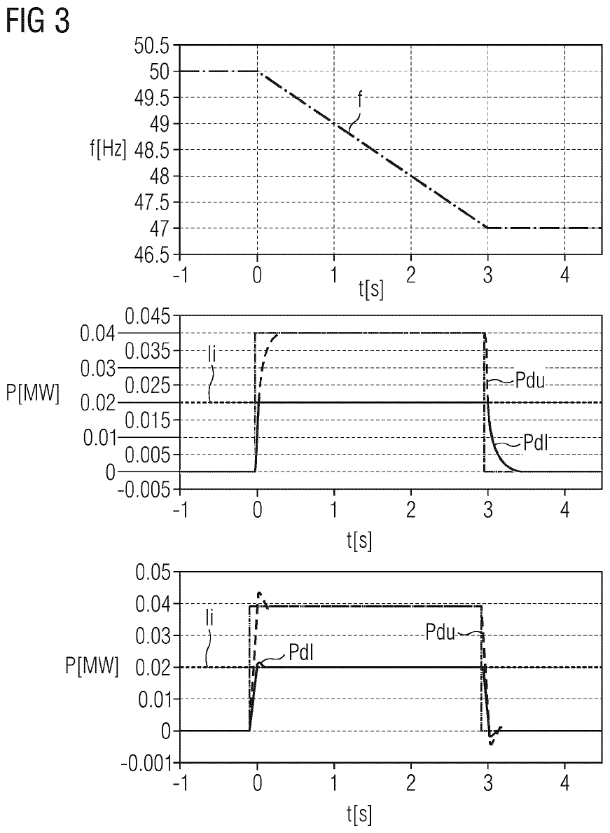

FIG. 3 illustrates exemplarily a first diagram showing a frequency variation over time, and a second and a third diagram showing an injected power over time; and

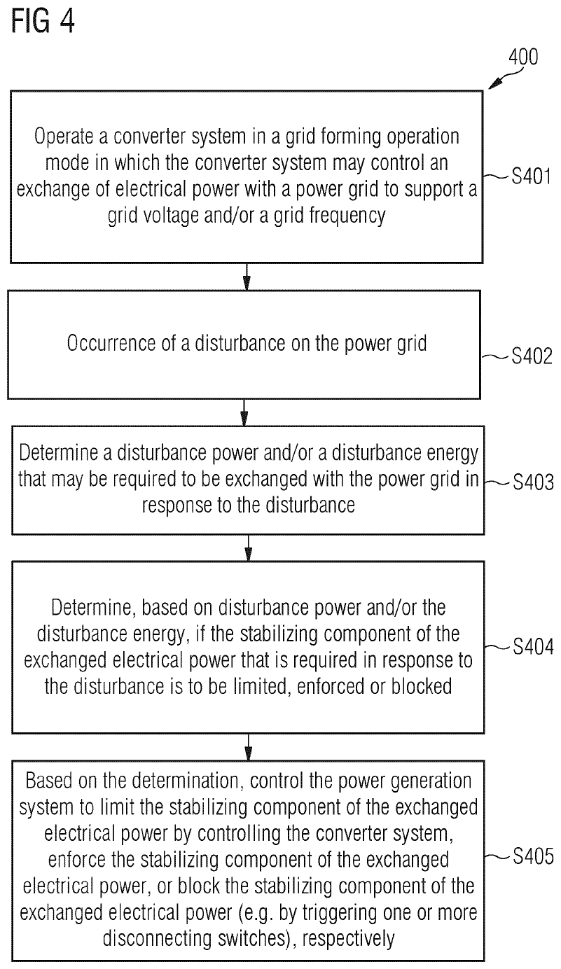

FIG. 4 is a schematic flow diagram illustrating a method 400 of controlling a power generation system according to an example.

### DETAILED DESCRIPTION

It is to be understood that the following description of the embodiments and/or examples is given only for the purpose of illustration and is not to be taken in a limiting sense. It should be noted that the drawings are to be regarded as being schematic representations only, and elements in the drawings are not necessarily to scale with each other. Rather, the representation of the various elements is chosen such that their function and general purpose become apparent to a person skilled in the conventional art. As used herein, the singular forms “a,” “an,” and “the” are intended to include the plural forms as well, unless the context clearly indicates otherwise. The terms “comprising,” “having,” “including,” and “containing” are to be construed as open-ended terms (i.e., meaning “including, but not limited to,”) unless otherwise noted.

In the following, the descriptions and explanations herein are related to a power generation system that comprises a power generation unit which is an electrical generator of a wind turbine. However, it should be clear that the power generation unit may be a different type of power source, e.g., a photovoltaic system and may be coupled to an energy storage system (e.g., a battery system or thermal energy storage) or the like. The power generation unit may also comprise a combination of plural power sources.

It should be clear that descriptions and explanations herein which are limited to one or more specific wind turbines may be applied to other or all wind turbines of a wind park comprising the specific wind turbine(s).

FIG. 1 is a schematic drawing showing a power generation system 10 and a control system 50 of a wind turbine 100. The figure further shows a signal flow chart illustrating an operation of controlling the power generation system 10 according to an example. The power generation system 10 may comprise the control system 50. The control system 50 may control an operation of the power generation system 10. The power generation system 10 may be coupled to a power grid 200 and may exchange electrical power P with the power grid 200.

The electrical power P may comprise active and/or reactive power. Power P may comprise at least a stabilizing component that is exchanged with the grid when a grid disturbance occurs. In embodiments, the power P may consist of or comprise only the stabilizing component. The power generation system 10 may comprise a power generation unit 20 and a converter system 30. The power generation unit 20 may generate/export and/or store/import electrical power. In an embodiment, the power generation unit 20 may be an electrical generator of the wind turbine 100 which is driven by a rotor of the wind turbine using wind power. The converter system 30 may be coupled to the power grid 200 and the power generation unit 20 and may convert at least a portion of, all of the electrical power P that is imported from or exported to the power grid. The converter system 30 and/or the power generation unit 20 may be controlled by the control system 50. The control system 50 may comprise a wind turbine controller 60 and a converter control 70. Each of the control systems 60, 70 may comprise a processing unit 61, 71 and a memory unit 62, 72. The wind turbine controller 60 may control an operation of the power generation system 10 and may at least indirectly (e.g., via units 70, 30) control power generation by generator 20. The converter control 70 may control an operation of the converter system 30. The control systems 60, 70 may be communicatively coupled to each other.

The converter system 30 may convert electrical power that is bidirectionally exchanged between the power generation unit 20 and the power grid 200. The converter system 30 may be operated in a grid forming mode in which the converter system is controlled so as to behave as an (ideal) voltage source, in particular as a Thevenin source and impedance. The voltage source may be controlled in frequency and in amplitude and the impedance may be emulated, a real impedance or a combination of both. Accordingly, the power generation system 10 may be operated so as to maintain a voltage amplitude, a voltage frequency and/or a voltage phase angle to control the electrical (active and reactive) power being exchanged with the power grid 200. In grid forming mode, the power generation system 10 may inherently provide instant power to suddenly changing loads in an electrical power system and, thus, react on incoming disturbances on the power grid. Such disturbance may for example comprise a deviation of an actual grid voltage or an actual grid frequency from a pre-event grid voltage or a pre-event grid frequency, respectively. Pre-event voltage and frequency may be close to the rated voltage and rated frequency of the power system. The severity of the disturbance may classify the disturbance as normal operation disturbance, severe disturbance or extreme disturbance. Depending on the severity of the disturbance, the grid forming initiated response on the disturbance may shift the power generation system into an operating point that is potentially harmful for the power generating system or that is at least inefficient or accompanied with a subsequent loss in power production.

When the converter system 30 is operated in the grid forming mode, an uncontrolled inherent response (e.g., without evaluating for system feasibility and/or without limiting) of the power generation system 10 to a grid disturbance in order to support the power grid may thus be disadvantageous, as a response to the disturbance may require an amount of electrical power beyond the given system capabilities and/or may shift the power generation system 10 into an inefficient operating point. In order to avoid that the power generation system 10 is shifted into such unfavorable operating point, the control system 50 may be configured to consider potential operating points in which the power generation system 10 may operate when the system would respond to an occurring disturbance. When it is determined that it is disadvantageous to respond to the disturbance, the control system 50 may control the power generation system 10 such that these disadvantages are avoided, e.g., blocked or rejected, or are at least reduced or limited. The amount of electrical power and energy that is exchanged between the grid 200 and the power generation system 10 for the support of the power grid in response to a disturbance is herein referred to as stabilizing component.

When a disturbance occurs, the converter control 70 may determine a disturbance power Pd and a disturbance energy Ed. The disturbance power Pd and the disturbance energy Ed may be indicative of the electrical power and energy that is required to be exchanged with the power grid 200 in response to the disturbance. The determined disturbance power Pd and the disturbance energy Ed may be provided to the wind turbine controller 60. The wind turbine controller 60 may determine one or more limits li based at least on the operating point of the wind turbine in terms of at least rotor speed or active power output, but potentially also including pitch angle, available wind estimation or measurement. The wind turbine controller 60 may from the received disturbance power Pd and the disturbance energy Ed choose to update the limit li if the impact on the wind turbine operating point from the disturbance necessitate further limitations and may return the limits li and one or more reference signals ref to the converter control 70. The limits may be predetermined or pre-programmed and stored in a look-up table. For example, the look-up table may store and return the one or more limits given the wind turbine rotor speed and/or active power output, and given one or more additional operational parameters of the power generation system 10. The determined disturbance power and/or the disturbance energy may be used in a comparison against the expected response of the wind turbine mechanical system to allow additional corrective actions and limitations if the actual response deviates too far from the expected. The limits li may be indicative of a limit of power. For example, the limits li may comprise a limit for a magnitude/an amplitude of the exchanged power and/or a limit for a power rate of the exchanged power, i.e., a derivative of the exchanged power over time or a change of the exchanged power over time. Alternatively, the limits li may be expressed by torque and more specifically, by a magnitude/an amplitude of the torque and/or a limit for a derivative of the torque over time or a change of the torque over time. The one or more reference signals ref may for example comprise a power reference, in accordance with which the power generating system 10 is operated during normal operation.

The converter control 70 may control the converter system 30 such that during the grid forming operation, the converter system 30 operates in accordance with the received reference signals ref and within the limits li. For example, the converter system 30 may be controlled so as to limit the stabilizing component and, thus, so as to limit the exchanged power P. Additionally or alternatively, the converter control 70 may receive a blocking/rejecting signal, in response to which the converter system may block/reject a provision of the stabilizing component. For example, the stabilizing component may be blocked when it is determined that performing a disturbance response may be harmful, in particular destructive, for the power generation system 10, or if the converter fails to limit the amount and/or the rate of change of disturbance power.

Additionally or alternatively, the control system may receive an enforcing signal, in response to which the control system may force the power generator's control system to provide the stabilizing component. For a wind turbine, the enforcing step may comprise temporarily blocking the normal speed/power control from responding to the decelerated rotor speed. Enforcing the response may be subject to the same or similar limits for the response as when the stabilizing component is not enforced. This may mean that the enforcing is lifted if the wind turbine is moving into an operating point that will cause an undesirable post-event response. For example, the stabilizing component may be enforced when the stabilizing power is required by a grid code or market commitments, e.g., by a contractually committed inertial power response.

FIG. 2 is a schematic drawing showing the control system 50 and a signal flow chart illustrating an operation of controlling the power generation system 10 according to an example. The operations that are included in the dashed box on the left may be comprised in and performed by the wind turbine controller 60. The operations that are included in the dashed box on the right may be comprised in and performed by the converter control 70. It should however be clear that the shown configuration for performing these operations is not limiting and that the operations may also be distributed in a different way among the depicted controls and/or even among other controls that are not depicted in FIG. 2 but included in or accessible by the power generation system 10. As can be seen in FIG. 2, the reference signal ref that is shown in FIG. 1 may comprise a reference power Pr (in particular a wind turbine generator reference power) in accordance with which the power generation system 10 exchanges power P with the power grid 200.

The reference power Pr may be generated by a speed/power control 66 that is comprised in the wind turbine controller 60. The generation may be based on actual operation parameters. The speed/power control 66 may obtain the actual operation parameters of the wind turbine. The parameters may comprise an actual rotational speed rsp that is indicative of a rotation of the wind turbine rotor or a rotation of the generator rotor, an actual wind speed wsp and an actual pitch angle pa. The actual operation parameters may be obtained by monitoring, in particular by measuring with a sensor system or by estimating. For example, the wind speed wsp may be estimated or received from an external source. The speed/power control 66 may perform a maximum power point tracking. The speed/power control may further obtain one or more limits li2 which may be provided by a controller of a higher hierarchy level, e.g., a wind park controller, and that may for example be indicative of a power reduction. Moreover, the speed/power controller 66 may output a logic signal lo being indicative of an operation mode in which the speed/power controller 66 currently operates. A power limit evaluation unit 65 may determine the one or more limits li based on the monitored actual operation parameters, namely the wind speed wsp, the rotational speed rsp and the pitch angle pa, and based on the determined disturbance power Pd, the determined disturbance energy Ed, and the determined reference Power Pr. Accordingly, the output limits li may be tailored to the current operation parameters and/or the severity of the disturbance.

In an embodiment, the power limit evaluation unit 65 may compare one or more predetermined thresholds to the inputs of the power limit evaluation unit 65 and/or a parameter derived from the inputs. For example, a threshold may comprise a power limit and/or an energy limit that is indicative of a maximum power/energy that the power generation system 10 or components of the power generation system 10 are capable to provide in a current operating point of the system or of its components. When one or more of the thresholds are exceeded, the power output of the system may be limited or blocked. The limits li may then for example be obtained by the look-up table. In an alternative example, at least one of the inputs of the power limit evaluation unit 65 may be directly fed into the look-up table and the results may be output as limits li. In another example, the limits li may be computed/derived from at least one of the inputs of the power limit evaluation unit 65, e.g., based on a mathematical model/equation or based on a simulation model. The power limit evaluation unit 65 may further consider hardware-based limitations, e.g., a maximum hardware limited power output or a maximum hardware limited energy storage capacity both of which may be dependent on the wind turbine operating point.

The logic signal lo and a mode signal m may be used to modify the operation of the power limit evaluation unit 65. Such modification may comprise how and when a limitation of the stabilizing component is performed. The modification may additionally comprise information on whether the speed/power control should change mode to enforce the stabilizing component. The mode signal m may be generated by a state machine 67 and the generation may be based on an actual grid frequency f, e.g., the grid voltage frequency, and an actual grid voltage v. The actual grid frequency f and the actual grid voltage v may be monitored.

The one or more limits li may be provided to a core control 75 and combined with the reference power Pr. In an embodiment, the actual active power output of the power generating system may deviate from the provided reference ref, e.g., the reference power Pr, during a power system frequency event. As long as the total active power output is within the limits li that are provided to the converter system, no additional action is required from the converter system. However, if the actual active power flow exceeds one or more of the received limits, the converter system engages additional control features to reject the disturbance power to bring the active power flow within the received limits li.

The core control 75 may be comprised in the converter control 70 which implements the grid forming control. Accordingly, the core control 75 may comprise a direct voltage control or cascaded voltage control, the cascaded voltage control comprising an inner current control. A reference voltage vr, which may be output by the core control 75, may be converted in corresponding switch commands sc by pulse-width modulation modulator unit 77. The switch commands sc may be provided to power electronic components, e.g., semiconductor switches such as IGBTs, of the converter system 30 in order to switch the power electronic components such that the actual power P that is exchanged with the power grid 200 in normal operation corresponds to the reference power Pr. The core control 75 may operate using the actual grid voltage and the actual grid current. The actual grid voltage and the actual grid current may be monitored. In an embodiment, the actual grid voltage may be the actual grid voltage vdq in the dq frame and the actual grid current may be the actual grid current idq in the dq frame. The voltage vdq and the current idq may be generated by transforming an actual grid voltage vabc in the abc frame and an actual grid current iabc in the abc frame into the dq frame using a d/q transformation and based on a determined phase angle theta th. The actual voltage vabc and actual current iabc may be monitored, e.g., measured, by feedback measurement unit 76. Feedback measurement unit 76 may further output the actual power P derived from the voltage vabc and the current iabc, the actual power P being the power that is actually exchanged (imported or exported) with the power grid 200.

The actual power P that is output by the converter system 50 may follow during steady state operation the reference power Pr that is received from the speed power controller 66. When a grid disturbance occurs, e.g., a frequency fluctuation, the actual power P may deviate from the reference power Pr and, thus, a control error may occur. In response to the control error, the control system 50 may control the power generation system 10 such that the control error is eliminated. As a result, additional power for responding to such a grid disturbance (i.e., the stabilizing component) may be exchanged with the grid, i.e., exported from the grid or imported into the grid. The additionally imported or exported power may result in (potentially harmful) burden for the power generation system 10 or may shift the operating point of the system 10 into an inefficient operating point. Depending on the severity of the disturbance, it may hence be beneficial to limit or block the additionally imported or exported power. The power limit evaluation unit 65 may therefore consider the disturbance power Pd and the disturbance energy Ed. The disturbance power Pd may be generated by subtracting the actual power P from the reference power Pr at coupling point 79 and, by filtering the difference with filter 74. The filter 74 may for example implement a low-pass filtering, e.g., for noise reduction. The disturbance energy Ed may be generated by subtracting the actual power P from the reference power Pr and by integrating the difference over time using integrator 78. In an embodiment, the integrated difference may be filtered with filter 73. The filter 73 may for example implement a low-pass filtering, e.g., for noise reduction. Alternatively, the disturbance energy Ed may be obtained by integrating the power disturbance Pd over time.

It should be clear that the hereinabove described control scheme and in particular the limits signal li may be used to implement each of the considered limiting, e.g., amplitude limit on active power and/or rate of change of power. The following is an example of a possible implementation: for the limiting, the limits signal li may comprise a maximum and/or a minimum value, including zero, indicative of a range of the allowed stabilizing power and/or a maximum rate of change of power. If the converter system fails to enforce the received limits, the control system may eventually decide to stop operation to protect the hardware, for example by tripping the power generation system (e.g., opening one or more disconnecting switches). Blocking the stabilizing power may thus comprise limiting the stabilizing power to zero and/or tripping the power generation system. If the control system is configured to enforce the stabilizing component, the control system will when entering into a frequency event ensure that the normal control actions of e.g., the speed/power control do not attempt to undo the stabilizing component unless the power limiting block has found that the response is detrimental to either the hardware or to the post event operation. Accordingly, the control scheme as shown in FIGS. 1 and 2 may be used to implement all modes (individually or in any combination): the limiting, the blocking and the enforcing modes.

FIG. 3 illustrates exemplarily a first (upper) diagram showing a frequency variation over time, and a second (middle) and third (lower) diagram, each of the second and third diagrams showing an injected disturbance power (stabilizing component) Pdu, Pdl over time. The disturbance power Pdu, Pdl is exchanged with the power grid 200 in response to a grid disturbance, which is in FIG. 3 exemplarily represented by the frequency variation/frequency fluctuation (graph f) in the first diagram. The unlimited disturbance power Pdu may represent the stabilizing component that is actually exchanged when the exchanged power P (the stabilizing component) is not limited, i.e., unlimited. The limited disturbance power Pdl may represent the stabilizing component that is actually exchanged when the exchanged power P (the stabilizing component) is limited. As mentioned, the disturbance power Pd may be estimated as/derived from the deviation of the actual power P from the reference power Pr, which deviation may occur when the power generation system 10 experiences sudden changes of grid characteristics, e.g., of the grid frequency or of the grid voltage. In such case, the grid dynamics may cause an additional import or export of power with the converter. The import or export is time limited as the converter control 70 continues controlling the power generation system 10 to the received power reference Pr. That process is exemplarily depicted in FIG. 3.

The first diagram of FIG. 3 depicts a frequency fluctuation, the frequency being decreased from 50 Hz to 47 Hz, e.g., in response to a sudden increase of grid load. The power generation system may react on such frequency fluctuation by additionally injecting disturbance power Pdu into the grid 200. As outlined above, it may be determined/evaluated that the magnitude of the required additional power Pdu may exceed a predetermined threshold or that injecting the additional power Pdu may shift the system 10 into an inefficient operating point. In response to such determination/evaluation (that may be performed before the power generation responds to the disturbance with a stabilizing component to counter the disturbance), the required unlimited power Pdu may be limited by the limit li such that the power generation system 10 may exchange only the limited disturbance power Pdl with the grid. The second diagram and the third diagram of FIG. 3 show that an application of the limit li reduces the power that is actually exchanged with the power grid during the limited operation down to about 50 percent of the power that is exchanged during the unlimited operation. The third diagram of FIG. 3 deviates from the second diagram in that a damping parameter of the power generation system 10 that influences the response of the power generation system 10 to the grid disturbance is set to a first value for the second diagram and is set to a second value below the first value for the third diagram. Due to the setting of the damping parameter, the second diagram depicts a non-oscillating system response, and the third diagram depicts a decaying oscillating system response. Both the second and third diagrams include a step function (from 0 to approximately 0.04 MW) that exemplarily represents as a respective reference signal, e.g., the reference power signal Pr. The reference signal may be modified (e.g., limited) by applying limits li to generate a modified (limited) step function (from 0 to approximately 0.02 MW). As a result, the output power of the power generation system may be modified correspondingly.

FIG. 4 is a schematic flow diagram illustrating a method 400 according to an example, which may be performed by control system 50. The sequence of the method steps in FIG. 4 is not limited to the sequence shown. In embodiments, the method is further not limited to the illustrated number of steps. Certain steps of embodiments of the method may not be carried out, may be replaced or extended.

FIG. 4 illustrates an exemplary method of controlling a power generation system. The power generation system may be electrically coupled to a power grid and may comprise a power generation unit generating electrical power and a converter system coupled to the power grid, as shown in FIG. 1. The converter system may convert at least electrical power that is exchanged between the power generation unit and the power grid. In step S401, the converter system is operated in a grid forming operation mode in which the converter system controls an exchange of electrical power with the power grid to support a grid voltage and/or a grid frequency. The exchanged electrical power may comprise a stabilizing component that provides this support during a grid disturbance. Based on the operating point and/or the operating conditions of the power generation system, one or more limits for disturbance power are sent to the converter system. In step S402, a disturbance occurs on the power grid, such as a drop in grid frequency, a voltage dip or the like, which may be detected. In step S403, a disturbance power and/or a disturbance energy is determined, which is exchanged with the power grid in response to the disturbance. As mentioned above, this may occur by monitoring the actual power provided to the power grid and determining the difference to a power reference that may be provided by a controller, such as the wind turbine controller.

In step S404, it is determined on the basis of the disturbance power and/or the disturbance energy if the stabilizing component of the exchanged electrical power that would be required for responding to the disturbance is to be limited, enforced or blocked. Based on the determination, the converter system may be controlled to limit the stabilizing component of the exchanged electrical power, the control system of the power generation system may enforce the stabilizing component of the exchanged electrical power or block the stabilizing component of the exchanged electrical power, respectively (step S405). The power limit evaluation unit 65 may during the event compare the expected and actual response of the power generating system to the monitored disturbance power and may update the limits signal accordingly. A respective limiting command may for example be provided from the power limit evaluation unit 65 to the core control 75, as shown in FIG. 2. The stabilizing component of the electrical power exchanged with the power grid may accordingly be limited as shown in the second and third diagrams of FIG. 3. In embodiments, the power generating system 10 may continue to operate with its undisturbed power output/exchange, and the additional stabilizing component of the exchanged electrical power caused by the disturbance may be limited as described herein, for example to avoid damage to system components, to avoid excessive slowdown of the wind turbine rotor or the like. Excessive slowdown may e.g., also trigger that the condition to enforce the stabilizing component is suspended if it is, e.g., judged that continued enforcement would result in a post-event response that would not justify contributing with the stabilizing component. If the converter system fails to limit the stabilizing component to the received limit values, the power limit evaluation unit 65 may order the power generating system to disconnect from the power system. Significant benefits may thus be achieved with the exemplary method.

As mentioned above, embodiments of the method may be performed by a power generation system of a wind turbine, but may also be performed correspondingly in another power generation system, such in a solar plant.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method of controlling a power generation system, wherein the power generation system is electrically coupled to a power grid and comprises a power generation unit generating electrical power and a converter system coupled to the power grid, wherein the converter system converts at least electrical power that is exchanged between the power generation unit and the power grid, and wherein the method comprises:
operating the converter system in a grid forming operation mode in which the converter system controls the exchange of electrical power with the power grid to support a grid voltage and/or a grid frequency, wherein during a disturbance of the power grid, the exchanged electrical power comprises a stabilizing component that provides the support,
wherein the method further comprises:
controlling the power generating system to at least one of
limit the stabilizing component of the exchanged electrical power by controlling the converter system,
enforce the stabilizing component of the exchanged electrical power, and
block the stabilizing component of the exchanged electrical power,
wherein said the enforcing comprises temporarily blocking a control response to a shifted operating point of the power generation system, and
wherein the method comprises:
determining a disturbance power and/or a disturbance energy that is required to be exchanged with the power grid in response to an occurrence of the disturbance, and
wherein the limiting, the enforcing, and the blocking of the stabilizing component, respectively, is based on at least the disturbance power and/or the disturbance energy and further on one or more operation parameters of the power generation system.

2. The method according to claim 1, wherein the limiting the stabilizing component of the exchanged electrical power comprises:
limiting a magnitude of the electrical power that is exchanged with the power grid, and/or
limiting a rate of change of the electrical power that is exchanged with the power grid.

3. The method according to claim 1, wherein the method comprises:
determining one or more limits based on at least the disturbance power and/or the disturbance energy and/or the one or more operation parameters of the power generation system, and
applying the one or more limits to limit the electrical power that is exchanged with the power grid.

4. The method according to claim 1, wherein the method comprises:
monitoring the grid voltage and/or the grid frequency to generate a monitored grid voltage and/or a monitored grid frequency:
determining an operation mode based on the monitored grid voltage and/or the monitored grid frequency; and
modifying, based on the operation mode, at least one of the limiting, the enforcing and the blocking of the stabilizing component.

5. The method according to claim 1, wherein the method comprises:
decoupling the power generation system from the power grid when the stabilizing component is blocked.

6. The method according to claim 1, wherein the power generation system is controlled so as to exchange power with the power grid in accordance with a reference power, and wherein the method comprises:
monitoring the power that is exchanged with the power grid to generate a monitored power,
wherein the disturbance power is determined based on a difference between the monitored power and the reference power, and wherein the method further comprises:
filtering the difference before the disturbance power is determined.

7. The method according to claim 6, wherein a power controller controls the power output of the power generation unit, and wherein the method comprises:
providing, by the power controller, the reference power.

8. The method according to claim 6, wherein monitoring the power comprises:
monitoring a grid voltage and a grid current to generate a monitored grid voltage and a monitored grid current, respectively, wherein the monitored power is generated by deriving the monitored power from the monitored grid voltage and the monitored grid current.

9. The method according to claim 1, wherein the method further comprises:
integrating a parameter that is indicative of the disturbance power,
wherein the disturbance energy is determined based on the integrated parameter,
wherein the method further comprises
filtering the integrated parameter before the disturbance energy is determined.

10. The method according to claim 1, wherein the method comprises:
determining that the disturbance power and/or the disturbance energy exceeds a respective threshold; and
wherein the stabilizing component is limited or blocked in response to the threshold being exceeded.

11. The method according to claim 1, wherein the method comprises:
determining that when the stabilizing component is exchanged with the power grid, that at least one of the operation parameters of the power generation system, of the power generation unit and/or the converter system, exceeds a respective threshold,
wherein the stabilizing component is limited or blocked in response to the threshold being exceeded.

12. A control system for controlling a power generation system, wherein the power generation system is configured to be electrically coupled to a power grid and comprises a power generation unit configured to generate electrical power and a converter system configured to be coupled to the power grid, wherein the converter system is configured to convert at least electrical power that is exchanged between the power generation unit and the power grid, and wherein the control system is configured to perform the method according to claim 1.

13. A power generation system, wherein the power generation system is configured to be electrically coupled to a power grid and wherein the power generation system comprises.
a power generation unit configured to generate electrical power,
a converter system configured to be coupled to the power grid, wherein the converter system is configured to convert at least electrical power that is exchanged between the power generation unit and the power grid, and
the control system according to claim 12, the control system being configured to control the power generation system.

14. The power generation system of claim 13, wherein the power generation unit is an electrical generator of a wind turbine.

15. A computer program product, comprising a computer readable hardware storage device having computer readable program code stored therein, said program code executable by a processor of a computer system to implement a method for controlling a power generation system, wherein the computer program product comprises control instructions which, when executed by one or more processing units, cause the one or more processing units to perform the method according to claim 1.
